(19) United States
(12) Patent Application Publication
(10) Pub. No.: US 2024/0192405 A1
(43) Pub. Date: Jun. 13, 2024

(54) Asymmetric Laplace-based wind power forecasting method and system

(71) Applicant: Central South University, Changsha (CN)

(72) Inventors: Yun WANG, Changsha (CN); Runmin ZOU, Changsha (CN); Qianyi LIU, Changsha (CN)

(21) Appl. No.: 18/585,790

(22) Filed: Feb. 23, 2024

Related U.S. Application Data
(63) Continuation of application No. 17/656,202, filed on Mar. 23, 2022.

(51) Int. Cl. G01W 1/10; G06N 3/08

(52) U.S. Cl. CPC G01W 1/10; G06N 3/08

(57) ABSTRACT

The invention provides a wind power forecasting method and system based on an asymmetric Laplace distribution. It utilizes the asymmetric Laplace distribution to model the uncertainty of the power forecasts. First, the maximum information coefficient (MIC) is used to characterize the linear and nonlinear relationship between the target and historical power data to select reasonable and optimal inputs. Then, to avoid the information loss, a multi-scale feature fusion module is proposed which combines the features obtained from different convolutional layers of a convolutional neural network (CNN), thereby further enhancing the feature extraction ability of the traditional CNN. Finally, a BiLSTM is used to extract temporal information and forecast the parameters of asymmetric Laplace distribution.

### CROSS-REFERENCE TO RELATED APPLICATIONS

This application is a Continuation of the U.S. application Ser. No. 17/656,202 filed on Mar. 23, 2022, and entitled “Asymmetric Laplace-based wind power forecasting method and system”, now pending, the entire disclosures of which are incorporated herein by reference.

### TECHNICAL FIELD

The embodiment of the invention relates to the technical field of wind power generation, and specially to a wind power forecasting method and system based on asymmetric Laplace distribution.

### BACKGROUND TECHNOLOGY

With the increasing problems of global energy shortage, climate change and environmental degradation, it is becoming more and more urgent to replace fossil fuels with renewable energy. Wind energy is a clean, pollution-free and renewable resource, which has attracted more and more attention all over the world. According to the statistical data in the Global Wind Energy Report in 2021, the new installed capacity will be about 93GW in 2020, and the global cumulative installed capacity will reach 743GW. It is expected that the new installed capacity of wind power will exceed 469GW in the next five years, that is, nearly 94GW will be added every year by 2025.

However, when large-scale wind power is connected to the grid, the randomness and intermittence of wind power will bring great challenges to the stability of the whole power grid. Therefore, it is necessary to plan a power generation system with sufficient reserve capacity to adapt to the uncertainty of wind power. Accurate prediction of wind power is an effective way to effectively solve a series of challenges in wind power grid connection. Specifically, it helps to minimize reserve capacity and optimize generation scheduling, so as to improve the stability and economy of the power system. In addition, accurate wind power prediction can predict the overhaul and maintenance requirements of wind turbines in advance and improve the competitiveness of wind power. At present, to accurately depict the complex fluctuation of wind power, researchers have designed many deterministic forecasting models, which can be roughly divided into four categories: physical model, traditional statistical model, artificial intelligence (AI) based model and hybrid model.

Physical models are usually composed of many complex mathematical formulas. They predict the future wind speed according to various meteorological factors, such as temperature, pressure and humidity. At present, the most common physical models are numerical weather prediction (NWP) and weather research and prediction (WRF). Generally, the physical model is suitable for medium and long-term wind speed prediction. Based on the wind speed forecasts, the final wind power forecasting result can be obtained through the wind power curve reflecting the power generation performance of the wind turbine at a given wind speed.

Traditional statistical models only use historical wind power data to predict future wind power. The most popular traditional statistical models in wind power forecasting are autoregressive moving average model (ARMA), autoregressive integrated moving average model (ARIMA) and truncated ARIMA model. In general, the traditional statistical methods mainly describe the linear fluctuation of wind power, and have good performance in ultra short-term and short-term wind power or wind speed prediction.

With the development of computer science and technology, more and more models based on artificial intelligence are used for wind power prediction, including artificial neural network (ANN), support vector machine (SVM), Kalman filter, extreme learning machine (ELM) and fuzzy logic model. Recently, due to its superior feature extraction and nonlinear fitting capabilities, deep learning methods have attracted more and more attention in wind power forecasting, such as convolutional neural network (CNN), deep belief network (DBN), long-short term memory model (LSTM) and gated recurrent unit (GRU), etc. Many studies show that in most cases, artificial intelligence-based models perform better than traditional statistical models, and prediction models based on deep learning can produce better wind power prediction results than some traditional machine learning techniques.

Hybrid models usually combine the advantages of different methods to improve the accuracy of wind power prediction. At present, there are mainly two strategies to build hybrid models. The first is to combine the forecasts of multiple forecasting methods; the second is to improve the accuracy of wind power prediction through other strategies or technologies, which include data processing methods (such as models based on empirical mode decomposition and wavelet decomposition) and feature selection methods (such as phase space reconstruction, mutual information and conditional mutual information). Generally, since the hybrid model combines the advantages of multiple models, its forecasts are better than a single forecasting model.

Most of the methods mentioned above are deterministic forecasting methods. However, deterministic prediction cannot reflect the uncertainty of wind power. Therefore, many researchers have developed uncertain wind power forecasting models, including probabilistic forecasting models and interval forecasting models. The main difference between them is that probabilistic models usually make a priori assumptions about the distribution of uncertainty and use continuous probability density function (PDF) to describe the uncertainty, while the interval-based models do not have any distribution assumptions and use discontinuous predictions intervals to quantify uncertainty.

The most common interval forecasting models are based on low upper-bound estimation (LUBE) and quantile-based regression models. The LUBE method proposed by Khosravi is mainly used to generate prediction intervals with narrow width and high coverage probability. Its main idea is to design appropriate objective functions for the generated prediction intervals. Quantile-based models are usually trained by minimizing quantile loss. Traditional quantile regression has limitations in dealing with nonlinear problems. Therefore, quantile regression is usually combined with other nonlinear models to obtain accurate prediction intervals. For example, the traditional support vector machine model and neural network can not directly obtain the prediction interval. Quantile loss is used to replace the loss function in the original model, and then support vector quantile regression and quantile regression neural network are generated, which overcomes the defect of weak ability of traditional quantile regression model to deal with nonlinear problems and generates prediction interval.

Most interval forecasting models can generate the required prediction interval at a given confidence level. If it is necessary to describe the continuous probability distribution of the whole uncertainty, it is necessary to make several forecasting models trained separately at different confidence levels, so it is very time-consuming.

For the probabilistic forecasting model, there are five representative methods: delta method, Bayesian method, mean variance estimation, bootstrap method and Gaussian process. They use Gaussian distribution and student's t distribution to describe the uncertainty. Generally speaking, almost all probabilistic models rely on the distribution assumption of wind power forecasting error, and face the risk of inconsistency between the theoretical distribution assumption and the actual uncertainty characteristics, which leads to the failure of the forecasting model to accurately describe the uncertainty of wind power forecasts.

### Content of the Invention

The invention provides a wind power forecasting method and system based on a asymmetric Laplace distribution. The asymmetric Laplace distribution can simultaneously fully describe the skewness and kurtosis of uncertainty. In order to solve the problem that the inconsistency between the theoretical distribution assumptions and realistic uncertainty characteristics, which makes the forecasting model cannot accurately describe the uncertainty of wind power forecasts, the asymmetric Laplace distribution is used to model the uncertainty of power forecasts.

A method for the asymmetric Laplace-based wind power forecasting, the method comprising:
Step S1: Obtaining the historical wind power data and use MIC to measure linear and nonlinear relationships between random variables to select optimal inputs, whose values of MIC should be greater than the given threshold;
Step S2: Constructing a neural network-based forecasting model with a multi-scale feature fusion module, the input of the model is a 1×1×d×1 tensor, wherein d is the input dimension;
Step S3: Deriving the loss function based on the maximum likelihood estimation of the asymmetric Laplace distribution, the model is trained with the selected inputs and the desired output to predict the parameters of the asymmetric Laplace distribution;
Step S4: Collecting the estimated parameters of the asymmetric Laplace distribution from the trained model, and using the mean statistics of the estimated asymmetric Laplace distribution as the deterministic forecast of wind power.

Further, the Step S1 specifically includes:
Step S11: Obtaining the historical wind power data, and divide it into training set, validation set and test set, which are normalized subsequently;
Step S12: Taking the wind power at time T+i as the target and calculate the MIC between the wind power at time T+i and time T, T−i, T−2i, . . . , T−ni. Then, select the historical wind power whose MIC value is greater than the given threshold as the input variable;

Further, the calculation of MIC in the Step S12 includes:

Given N samples D={(xᵢ, yᵢ)|i=1, 2, . . . , N} that related to the input variable X and the output variable Y, all inputs and outputs are divided into m and n intervals, respectively, thus forming an m×n grid G;

According to the empirical joint probability distribution p(x,y) of X and Y, the corresponding empirical marginal distributions p(x) and p(y) can be estimated, under the condition of sample D and grid G, the mutual information MI(X, Y|D, G) between X and Y can be expressed as:

$$\\ MI ( X , Y \vert D , G ) = {\sum }_{x ∈ X} {\sum }_{y ∈ Y} p ( x , y ) {log}_{2} ( \frac{p ( x , y )}{p ( x ) p ( y )} ) ;$$

The standardized maximum mutual information NMI*(D,m,n) based on grid G can be expressed as:

$$\\ N M {I}^{{}_{} *} ( D , m , n ) = \frac{{max}_{G} MI ( X , Y \vert D , G )}{log min \{ m , n \}} ;$$

The MIC between X and Y can be computed as:

$$\\ M I C ( X , Y ) = {max}_{m \times n < k ( N )} \{ N M {I}^{{}_{} *} ( D , m , n ) \} ,$$

wherein k(N) is the function related to the sample size.

Further, the multi-scale feature fusion module in the Step S2 includes a 1-dimension CNN (1D-CNN) with three convolutional layers, in which the kernel size is k×1, and the corresponding output is a 1×1×d×k tensor. The output of each convolutional layer is flattened into a 1×1×q tensor, where q=d×k;

The output of the multi-scale feature fusion module is [symbol] _{fusion}= [symbol] _{conv1}+ [symbol] _{conv2}+ [symbol] _{conv3}, where [symbol] _{conv1}, [symbol] _{conv2}, and [symbol] _{conv3} are the flattened outputs of three convolutional layers.

Further, the Step S3 specifically includes:

Step S31: Determine the probability distribution function of the asymmetric Laplace distribution:

$$\\ AsyL ( x \vert κ , μ , s ) = \{ \begin{matrix}\frac{κ}{s ( {κ}^{{}_{} 2} + 1 )} exp ( - \frac{κ ( x - μ )}{s} ) , & x \geq μ \\ \frac{κ}{s ( {κ}^{{}_{} 2} + 1 )} exp ( - \frac{{κ}^{- 1} ( x - μ )}{s} ) , & x < μ\end{matrix} ,$$

wherein x∈(−∞,+∞), κ>0, κ is the shape parameter, μ is the position parameter, and s is the scale parameter;

Step S32: For the input xᵢ, the parameters κ, μ, s vary with different features; given N training samples, the likelihood function is:

$$\\ L = {\prod }_{i = 1}^{N} AsyL ( {y}_{i} \vert κ ( {x}_{i} ) , μ ( {x}_{i} ) , s ( {x}_{i} ) ) ;$$

Step S33: Based on the proposed neural network, the parameters of the symmetric Laplace distribution are obtained by maximizing the log-likelihood function. The loss function is:

$$\\ L ( {y}_{i} , {\hat{y}}_{i} ) = - {\sum }_{i}^{N} log κ ( {x}_{i} ) - log ( κ {( {x}_{i} )}^{2} + 1 ) - log s ( {x}_{i} ) + {\sum }_{i}^{N} \{ \begin{matrix}- \frac{κ ( {x}_{i} ) ( {y}_{i} - μ ( {x}_{i} ) )}{s ( {x}_{i} )} , & {y}_{i} \geq μ ( {x}_{i} ) \\ \frac{{κ ( {x}_{i} )}^{- 1} ( {y}_{i} - μ ( {x}_{i} ) )}{s ( {x}_{i} )} , & {y}_{i} < μ ( {x}_{i} )\end{matrix} ,$$

where ŷᵢ=[μ(xᵢ), κ(xᵢ), s(xᵢ)]. The above loss function is employed to train the proposed neural network.

Further, in the Step S4, the deterministic forecasting result of wind power can be seen as the mean statistics of the asymmetric Laplace distribution, which can be expressed as:

$$\\ {Mean}_{AsyL} = {μ}^{{}_{} *} - \frac{{s}^{{}_{} *} ( {κ}^{{}_{} * 2} - 1 )}{{κ}^{{}_{} *}} ,$$

wherein μ*, κ*, s* are the forecasts of the position parameter, shape parameter and scale parameter in the asymmetric Laplace distribution, respectively.

A system for the proposed asymmetric Laplace distribution-based wind power forecasting comprising:
Collection module, obtaining historical wind power data and use the MIC to determine the input variables;
Neural network module, constructing a multi-scale feature fusion module, the input of the model is a 1×1×d×1 tensor, wherein d is the input dimension;
Training module, the loss function is obtained based on the maximum likelihood estimation of the asymmetric Laplace distribution, and the model is trained to predict the parameters of the asymmetric Laplace distribution;
Prediction module, the parameters of the asymmetric Laplace distribution are determined based on the trained model, and the mean statistics of the parameters of the asymmetric Laplace distribution are used as the deterministic forecasts of the wind power.

An electronic device comprising a memory, a processor, and a computer program which is stored on the memory and can run on the processor, the program executed by the processor implements the steps of asymmetric laplace-based wind power forecasting method.

A non-transitory computer-readable storage medium on which a computer program is stored, the program executed by the processor implements the steps of asymmetric laplace-based wind power forecasting method.

The invention provides a wind power forecasting method and system based on an asymmetric Laplace distribution. It utilizes the asymmetric Laplace distribution to model the uncertainty of the power forecasts. First, the maximum information coefficient (MIC) is used to characterize the linear and nonlinear relationship between the target and historical power data to select reasonable and optimal inputs. Then, to avoid the information loss, a multi-scale feature fusion module is proposed which combines the features obtained from different convolutional layers of a convolutional neural network (CNN), thereby further enhancing the feature extraction ability of the traditional CNN. Finally, a BiLSTM is used to extract temporal information and forecast the parameters of asymmetric Laplace distribution.

### BRIEF DESCRIPTION OF THE DRAWINGS

In order to explain the embodiments of the invention or the technical solutions more clearly, the used figures will be briefly introduced as follows.

FIG. 1 depicts the flowchart of the asymmetric Laplace-based wind power forecasting method in the embodiment of the present invention.

FIG. 2 depicts a schematic diagram of MIC values on two datasets according to the embodiment of the present invention.

FIG. 3 depicts a schematic diagram of the interval forecasting result and the deterministic forecasting result of the model AL-MCNN-BiLSTM on BE-ON according to the embodiment of the present invention.

FIG. 4 depicts a schematic diagram of the interval forecasting result and the deterministic forecasting result of the model AL-MCNN-BiLSTM on BE-OFF according to the embodiment of the present invention.

FIG. 5 depicts a schematic diagram of an entity structure according to the embodiment of the present invention.

### SPECIFIC IMPLEMENTATION

In order to make the objectives, technical solutions and advantages of the embodiments of the invention clearer, the technical solutions in the embodiments of the invention will be described clearly and completely with reference to the accompanying pictures. Obviously, the described embodiments are part of the embodiments of the invention. Based on the embodiments of the invention, all other embodiments obtained by those of ordinary skill in the art without creative work shall fall within the protection scope of the present invention.

The term “and/or” in the embodiment of the present invention is merely an association relationship describing associated objects, indicating that there can be three types of relationships, for example, A and/or B, which can mean that A exists alone, and A and B exist at the same time, B exists alone, these three situations.

The terms “first” and “second” in the embodiments of the present application are only used for descriptive purposes, and cannot be understood as indicating or implying relative importance or implicitly indicating the number of indicated technical features. Therefore, the features defined with “first” and “second” may explicitly or implicitly include at least one of the features. In the description of this application, the terms “include” and “have” and any variations thereof are intended to cover non-exclusive inclusion. For example, a system, product, or device that includes a series of components or units is not limited to the listed components or units, but alternatively includes unlisted components or units, or alternatively include other components or units inherent to these products or devices. In the description of the present application, “a plurality of” means at least two, such as two, three, etc., unless otherwise specifically defined.

Reference to “embodiments” herein means that a specific feature, structure, or characteristic described in conjunction with the embodiments may be included in at least one embodiment of the present application. The appearance of the phrase in various places in the specification does not necessarily refer to the same embodiment, nor is it an independent or alternative embodiment mutually exclusive with other embodiments. Those skilled in the art clearly and implicitly understand that the embodiments described herein can be combined with other embodiments.

In the existing technology, almost all probabilistic models rely on the distribution hypothesis of wind power forecasting error, and are faced with the risk that the theoretical distribution hypothesis is inconsistent with the actual uncertainty characteristics, which make the model cannot accurately depict the uncertainty.

Compared with interval based-models, probabilistic models may be more efficient as they directly output continuous PDFs with more information than discrete PIs. Moreover, due to the characteristics of the PDF, probabilistic models can overcome the risk of overlap in the generated PIs. Therefore, the focus of this embodiment is to designing an appropriate probabilistic wind power forecasting method to depict the uncertainty of wind power prediction. At present, many scholars have found that the uncertainty in wind power prediction is skewed with high kurtosis. Therefore, it is challenging to construct a suitable prediction model to extract more effective information and accurately describe the uncertainty of wind power.

Therefore, the embodiments provides a wind power forecasting method and system based on an asymmetric Laplace distribution. The asymmetric Laplace distribution can simultaneously fully describe the skewness and kurtosis of uncertainty. In order to solve the problem that the inconsistency between the theoretical distribution assumptions and realistic uncertainty characteristics, which makes the forecasting model cannot accurately describe the uncertainty of wind power forecasts, the asymmetric Laplace distribution is used to model the uncertainty of power forecasts. In the following, a lot of embodiments will be used to expand the description and introduction of the invention.

FIG. 1 provides an asymmetric Laplace-based wind power forecasting method and system for the invention, including:

Step S1: Obtaining the historical wind power data and use MIC to measure linear and nonlinear relationships between random variables to select optimal inputs, whose values of MIC should be greater than the given threshold.

Step S11: Obtaining the historical wind power data, and divide it into training set, validation set and test set, which are normalized subsequently.

Specifically, in some embodiments, the historical wind power data is selected for experiments. The entire wind power dataset is divided into three subsets, namely training set, validation set and test set. The training set is used to train the model, the validation set assists the optimal model parameter selection, and the test set is used to test the forecasting performance of the model. In order to facilitate model training, all data are normalized in the following way:

$$\tilde{x} = \frac{x - {x}_{min}}{{x}_{max} - {x}_{min}} ,$$

where \tilde{x} represents the processed data, x is the original data, xₘₐₓ and xₘᵢₙ respectively represent the maximum and minimum values in the sequence.

Step S12: Taking the wind power at time T+i as the target and calculate the MIC between the wind power at time T+i and time T, T−i, T−2i, . . . , T−ni. Then, selecting the historical wind power whose MIC value is greater than the given threshold as the input variable.

This step mainly focuses on selecting the optimal inputs. Appropriate input features can accurately capture wind power fluctuations, thereby realizing accurate wind power forecasting. Neither redundant features nor insufficient features can accurately describe the complex fluctuations of wind power. Because the MIC value can measure not only the linear relationship between two random variables, but also the nonlinear relationship between two variables. Therefore, this invention uses the MIC value to select the best input for wind power forecasting. The MIC value between two random variables (X, Y) is calculated as follows:

Given N samples D={(xᵢ, yᵢ)|i=1, 2, . . . , N} that related to the input variable X and the output variable Y, all inputs and outputs are divided into m and n intervals, respectively, thus forming an m×n grid G; According to the empirical joint probability distribution p(x, y) of X and Y, the corresponding empirical marginal distributions p(x) and p(y) can be estimated, under the condition of sample D and grid G, the mutual information MI(X, Y|D, G) between X and Y can be expressed as:

$$MI ( X , Y \vert D , G ) = {\sum }_{x ∈ X} {\sum }_{y ∈ Y} p ( x , y ) {log}_{2} ( \frac{p ( x , y )}{p ( x ) p ( y )} ) ;$$

The standardized maximum mutual information NMI*(D,m,n) based on grid G can be expressed as:

$${NMI}^{*} ( D , m , n ) = \frac{{max}_{G} MI ( X , Y \vert D , G )}{log min \{ m , n \}} ;$$

The MIC between X and Y can be computed as:

$$MIC ( X , Y ) = {max}_{m \times n < k ( N )} \{ {NMI}^{*} ( D , m , n ) \} ,$$

wherein k(N) is the maximum grid size, which is a function of the number of samples N, and can be set as k(N)=N^{0.6}.

Except for its universal applicability for measuring both linear and nonlinear relationship, MIC also has the following three basic properties: (1) Bounded value, MIC∈[0,1]; (2) Symmetrical characteristic, MIC(X,Y)=MIC (Y,X); (3) Low computational complexity and high robustness.

Step S2: Constructing a neural network-based forecasting model with a multi-scale feature fusion module; the input of the model is a 1×1×d×1 tensor, wherein d is the input dimension.

In some embodiments, a multi-scale feature fusion module is proposed for fully extracting spatial features in data, while BiLSTM is used to extract temporal features. For the traditional CNN, different convolutional layers usually extract features at different scales from the data. As the number of convolutional layers increases, deeper and more abstract features can be extracted. Usually, only the deep features extracted by the last convolutional layer are used for forecasting or input into another network, while the shallow features are directly discarded. Therefore, the multi-scale features in CNN are not fully utilized, and there is a risk of information loss.

In some embodiments, a CNN network based on a multi-scale feature fusion module, namely MCNN, is proposed to solve the problem of information loss. Suppose inputting d-dimensional historical power data, which is converted it into a 1×1×d×1 tensor X, into a 1-dimensional CNN network with 3 convolutional layers, whose kernel size is k×1, activation function is ReLU, the strider is 1, and the padding method is “same”. For each convolutional layer, the output layer is a 1×1×d×k tensor, which is flattened into a 1×1×q tensor, where q=d×k. The flattened outputs of the 3 convolutional layers are respectively denoted as [symbol] _{conv1}, [symbol] _{conv2} and [symbol] _{conv3}. The output of the multi-scale feature fusion module is [symbol] _{fusion}= [symbol] _{conv1}+ [symbol] _{conv2}+ [symbol] _{conv3}.

The fused features are regularized into a 1×d×k tensor and then input into a BiLSTM model for temporal feature extraction, and finally the final output result is obtained through two fully connected layers.

Step S3: Deriving the loss function based on the maximum likelihood estimation of the asymmetric Laplace distribution. The model is trained with the selected inputs and the desired output to predict the parameters of the asymmetric Laplace distribution.

Step S31: Determine the probability distribution function of the asymmetric Laplace distribution:

$$AsyL ( x \vert κ , μ , s ) = \{ \begin{matrix}\frac{κ}{s ( {κ}^{2} + 1 )} exp ( - \frac{κ ( x - μ )}{s} ) , & x \geq μ \\ \frac{κ}{s ( {κ}^{2} + 1 )} exp ( - \frac{{κ}^{- 1} ( x - μ )}{s} ) , & x < μ\end{matrix} ,$$

wherein x∈(−∞,+∞), κ>0, κ is the shape parameter, μ is the position parameter, and s is the scale parameter;

Step S32: For the input xᵢ, the parameters κ, μ, s vary with different features; given N training samples, the likelihood function is:

$$L = {\prod }_{i = 1}^{N} AsyL ( {y}_{i} \vert κ ( {x}_{i} ) , μ ( {x}_{i} ) , s ( {x}_{i} ) ) ;$$

Step S33: Based on the proposed neural network, the parameters of the symmetric Laplace distribution are obtained by maximizing the log-likelihood function. The loss function is:

$$L ( {y}_{i} , {\hat{y}}_{i} ) = - {\sum }_{i}^{N} log κ ( {x}_{i} ) - log ( {κ ( {x}_{i} )}^{2} + 1 ) - log s ( {x}_{i} ) + {\sum }_{i}^{N} \{ \begin{matrix}- \frac{κ ( {x}_{i} ) ( {y}_{i} - μ ( {x}_{i} ) )}{s ( {x}_{i} )} , & {y}_{i} \geq μ ( {x}_{i} ) \\ \frac{{κ ( {x}_{i} )}^{- 1} ( {y}_{i} - μ ( {x}_{i} ) )}{s ( {x}_{i} )} , & {y}_{i} < μ ( {x}_{i} )\end{matrix} ,$$

where ŷᵢ=[μ(xᵢ), κ(xᵢ), s(xᵢ)] represents the output vector of the neural network. The above loss function is employed to train the proposed neural network.

Step S4: Collecting the estimated parameters of the asymmetric Laplace distribution from the trained model, and using the mean statistics of the estimated asymmetric Laplace distribution as the deterministic forecast of wind power.

The method for the asymmetric Laplace-based wind power forecasting according to the Claim 5, in the Step S4, the deterministic forecasting result of wind power can be seen as the mean statistics of the asymmetric Laplace distribution, which can be expressed as:

$${Mean}_{AsyL} = {μ}^{*} - \frac{{s}^{*} ( {κ}^{* 2} - 1 )}{{κ}^{*}} ,$$

wherein μ*, κ*, s* are the forecasts of the position parameter, shape parameter and scale parameter in the asymmetric Laplace distribution, respectively.

In some embodiments, the onshore and offshore wind power dataset of Belgian in 2019 is also used to evaluate the effectiveness of the proposed model. The time scale of the wind power data is 1 hour. The first 10 months of data are used as training samples to train the model, and the remaining 2 months of data are used as the validation set and test set respectively. The validation set is used to assist in selecting the optimal parameters of the model, and the test set is used to test the forecasting performance of the model. For the convenience of description, the onshore and offshore datasets are respectively named BE-ON and BE-OFF.

In some embodiments, to evaluate the deterministic forecasting performance of different models, four metrics are used: the coefficient of determination (R²), mean absolute error (MAE), root mean squared error (RMSE), and improved mean absolute percentage Error (MMAPE). To evaluate the probabilistic forecasting result of the model, the embodiment adopts three evaluation metrics: pinball loss (PL), Winkler score (WS), and coverage width criterion (CWC).

To evaluate the wind power deterministic forecasting performance of the proposed method in the embodiment, the embodiment considers the following benchmark models: the persistence, SVM, BPNN, CNN, LSTM, bidirectional LSTM (BiLSTM), CNN-LSTM, CNN-BiLSTM, and MCNN-BiLSTM. For CNN-LSTM and CNN-BiLSTM, there is no multi-scale feature fusion layer, and the output of the convolutional layer is directly input to LSTM and BiLSTM. The model MCNN-BiLSTM includes a multi-scale feature fusion layer, and the loss function used is MSE. To illustrate the superiority of the proposed method, the embodiment uses two types of benchmark models. The first category is the interval model that uses the interval metric as the loss function, such as the average PL based LSTM (PL-LSTM), the interval estimation error (PIEE) based LSTM (PIEE-LSTM), and the traditional quantile regression model (QR) which uses PL as loss function. The second category is probabilistic forecasting models, including Gaussian process (GP), and Gaussian and Laplace based CNN, LSTM, BiLSTM, CNN-LSTM and CNN-BiLSTM models.

In some embodiments, the validation set is used to select the optimal parameters of the model. For the CNN-based model, three convolutional layers are used, and the optimal number and size of convolution kernel are selected from {16,32,64,128} and {1,2,3,4}, respectively. For LSTM and BiLSTM based models, the optimal number of hidden nodes is selected from {50,100,150,200}. For all deep learning models in this embodiment, the Adam optimizer is used for model training. For the deep learning-based deterministic forecasting models, the loss function used is the MSE.

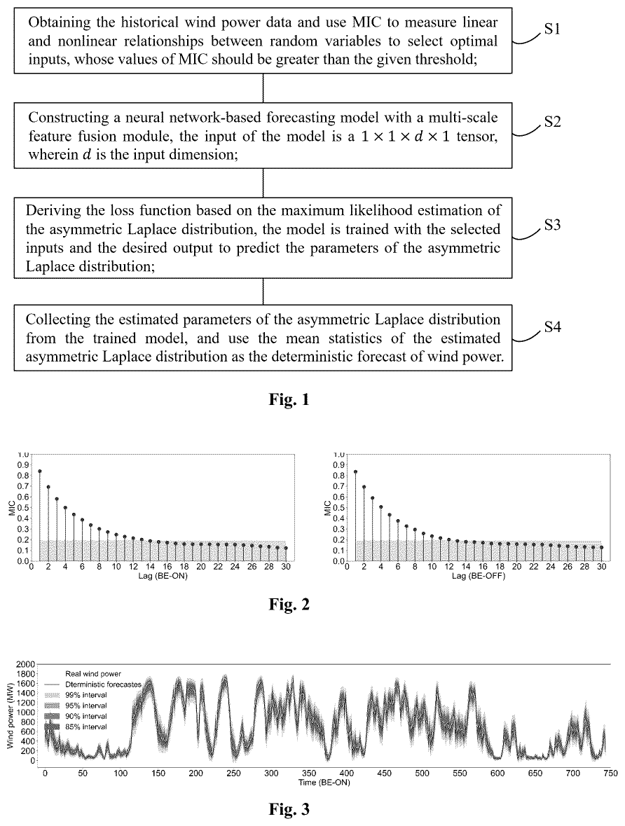

In some embodiments, MIC is used to select the optimal inputs. The larger the MIC value, the better the input. In the experiment, the maximum lag of the power data is selected as 30. FIG. 2 shows the MIC values in different datasets. The gray area indicates that the value of MIC is less than 0.2. The historical power data whose MIC value exceeds the gray area is selected as the optimal model input. Therefore, the optimal lag order is 12 for both data sets. In order to describe the fluctuation of wind power at time t+1, the optimal input is {WP(t), WP(t−1), . . . , WP(t−11)}. The deterministic forecasting results of all models are shown in Table 1.

TABLE 1
Deterministic forecasting results of different models.

| | BE-ON | | | | BE-OFF | | | |
|---|---|---|---|---|---|---|---|---|
| Model | R² | MAE | RMSE | MMAPE | R² | MAE | RMSE | MMAPE |
| Persistence | 0.9645 | 64.6622 | 90.2571 | 9.6445 | 0.9374 | 76.6875 | 130.8181 | 8.8145 |
| SVM | 0.9699 | 64.1163 | 83.1517 | 9.5631 | 0.9496 | 88.0641 | 117.3152 | 10.1221 |
| BPNN | 0.9716 | 57.6901 | 80.7319 | 8.6046 | 0.9490 | 81.7788 | 118.0453 | 9.3997 |
| CNN | 0.9729 | 55.9937 | 78.8904 | 8.3516 | 0.9504 | 75.0453 | 116.3682 | 8.6257 |
| LSTM | 0.9733 | 55.8556 | 78.2684 | 8.3310 | 0.9545 | 72.1890 | 111.4754 | 8.2974 |
| BiLSTM | 0.9732 | 56.1167 | 78.4596 | 8.3699 | 0.9519 | 78.2555 | 114.6600 | 8.9947 |
| CNN-LSTM | 0.9737 | 55.4676 | 77.7253 | 8.2731 | 0.9513 | 77.7814 | 115.3322 | 8.9402 |
| CNN-BiLSTM | 0.9737 | 55.1371 | 77.6744 | 8.2238 | 0.9499 | 80.1841 | 116.9621 | 9.2164 |
| MCNN-BiLSTM | 0.9738 | 55.0989 | 77.5861 | 8.2181 | 0.9508 | 73.2334 | 115.9004 | 8.4175 |
| AL-MCNN-BiLSTM | 0.9743 | 54.8054 | 76.8592 | 8.1743 | 0.9548 | 72.0153 | 111.1470 | 8.2775 |

It can be seen from Table 1 that the performance of the proposed model AL-MCNN-BiLSTM is better than the other 9 benchmark models, and almost all the deep learning-based models are better than the traditional wind power forecasting methods. Three single deep learning models (CNN, LSTM, and BiLSTM) have similar performance on two datasets. For the hybrid models CNN-LSTM and CNN-BiLSTM, which combine the advantages of the two deep learning models, their performance should be better than the single deep learning model in theory. However, in practice, the complex model structure and combination way limit the performance of the hybrid model. Therefore, the performance of hybrid model is sometimes worse than that of the single model. For example, on Dataset BE-OFF, according to the four metrics, the performance of CNN-BiLSTM is worse than that of CNN and BiLSTM.

The comparison between the model MCNN-BiLSTM and CNN-BiLSTM shows that different combination strategies can lead to different forecasting performance. In the MCNN-BiLSTM, the multi-scale features of different convolutional layers are fused and then input into a BiLSTM, while CNN-BiLSTM only uses the features from the last convolutional layer of CNN. From Table 1, MCNN-BiLSTM is better than CNN-BiLSTM in 1 hour ahead wind power forecasting. This phenomenon indicates that multi-scale feature fusion module can help improve forecasting performance. The reason may be that the full use of multi-scale information, thus avoiding the information loss.

The difference between AL-MCNN-BiLSTM and MCNN-BiLSTM lies in the loss function. The proposed model does not directly output the deterministic wind power forecasts, but is derived from the forecasted probabilistic distribution, and the uncertainty characterized by the asymmetric Laplace distribution is also considered in the loss function. However, the MSE loss function used to train MCNN-BiLSTM does not consider any uncertainty. It can be seen from Table 1 that the performance of AL-MCNN-BiLSTM is better than MCNN-BiLSTM on both datasets. From the analysis of the results, considering the uncertainty in the loss function helps to improve the deterministic forecasting accuracy.

To illustrate the performance of probabilistic wind power forecasting, this embodiment compares the prediction intervals (PIs) at 85%, 90%, and 95% confidence levels, and the results are shown in Table 2 and Table 3.

TABLE 2
Probabilistic forecasting results of different models on Dataset BE-ON.

| | 85% | | | 90% | | | 95% | | |
|---|---|---|---|---|---|---|---|---|---|
| Model | PL | WS | CWC | PL | WS | CWC | PL | WS | CWC |
| GP | 12.7241 | −101.7930 | 86.5849 | 9.9809 | −79.8476 | 122.8429 | 6.5814 | −52.6514 | 3.2289 |
| QR | 11.2059 | −89.6475 | 1.7664 | 8.3799 | −67.0392 | 1.4212 | 5.0038 | −40.0301 | 1.3192 |
| PL-LSTM | 11.1160 | −88.9276 | 2.7564 | 8.4572 | −67.6576 | 6.5179 | 5.1453 | −41.1628 | 4.4923 |
| PIRR-LSTM | 11.5271 | −92.2167 | 7.8345 | 8.7616 | −70.0930 | 4.3921 | 4.9758 | −39.8064 | 2.5195 |
| AL-CNN | 11.2670 | −90.1364 | 6.4044 | 8.4648 | −67.7180 | 3.1805 | 5.0908 | −40.7261 | 1.7463 |
| AL-LSTM | 11.0065 | −88.0523 | 4.3283 | 8.2684 | −66.1471 | 2.4584 | 4.9370 | −39.4959 | 2.6913 |
| AL-BiLSTM | 11.0239 | −88.1912 | 14.2562 | 8.2651 | −66.1208 | 6.9449 | 4.8955 | −39.1642 | 5.8300 |
| AL-CNN-LSTM | 10.9899 | −87.9194 | 2.4201 | 8.2278 | −65.8221 | 1.8051 | 4.8352 | −38.6814 | 1.3909 |
| AL-MCNN-LSTM | 10.7732 | −86.1856 | 5.6068 | 8.0772 | −64.6178 | 4.1225 | 4.7546 | −38.0365 | 2.8707 |
| AL-CNN-BiLSTM | 10.9754 | −87.8034 | 3.3316 | 8.2504 | −66.0030 | 2.9906 | 4.8267 | −38.6133 | 2.8776 |
| G-MCNN-BiLSTM | 10.9038 | −87.2303 | 1.9900 | 8.2470 | −65.9761 | 4.3915 | 4.9623 | −39.6986 | 5.1060 |
| L-MCNN-BiLSTM | 10.9074 | −87.2591 | 11.6328 | 8.1882 | −65.5052 | 5.0035 | 4.8439 | −38.7510 | 2.6835 |
| AL-MCNN-BiLSTM | 10.6763 | −85.4105 | 0.1242 | 7.9284 | −63.4272 | 0.1506 | 4.6557 | −37.2456 | 0.1958 |

TABLE 3
Probabilistic forecasting results of different models on Dataset BE-OFF.

| | 85% | | | 90% | | | 95% | | |
|---|---|---|---|---|---|---|---|---|---|
| Model | PL | WS | CWC | PL | WS | CWC | PL | WS | CWC |
| GP | 18.1388 | −145.1105 | 0.2098 | 14.1033 | −112.8268 | 1.5109 | 9.0114 | −72.0916 | 3.5892 |
| QR | 17.8858 | −143.0863 | 3.0025 | 13.9192 | −111.3533 | 2.1446 | 8.7153 | −69.7227 | 2.2646 |
| PL- LSTM | 16.8904 | −135.1230 | 26.0892 | 12.9539 | −103.6310 | 3.2628 | 8.3326 | −66.6611 | 2.6631 |
| PIRR-LSTM | 17.2295 | −137.8360 | 1.7018 | 12.6517 | −101.2130 | 1.7520 | 8.2474 | −65.9788 | 2.2076 |
| AL-CNN | 16.0693 | −128.5540 | 33.9484 | 12.1898 | −97.5180 | 8.0054 | 7.3888 | −59.1106 | 3.8009 |
| AL-LSTM | 16.2249 | −129.7990 | 2.3062 | 12.7290 | −101.8320 | 2.5182 | 8.2105 | −65.6840 | 3.3425 |
| AL-BiLSTM | 15.6475 | −125.1800 | 5.2983 | 12.2388 | −97.9101 | 5.0525 | 7.7947 | −62.3573 | 5.1775 |
| AL-CNN-LSTM | 15.0526 | −120.4210 | 5.3032 | 11.2727 | −90.1816 | 4.4422 | 6.7954 | −54.3632 | 3.3281 |
| AL-MCNN-LSTM | 14.8357 | −118.6850 | 2.9614 | 11.1965 | −89.5721 | 4.1719 | 6.6662 | −53.3296 | 3.1162 |
| AL-CNN-BiLSTM | 14.7008 | −117.6060 | 0.1971 | 11.1777 | −89.4214 | 0.2387 | 6.7687 | −54.1498 | 0.3097 |
| G-MCNN-BiLSTM | 14.5377 | −116.3020 | 1.6944 | 11.0870 | −88.6958 | 3.0373 | 6.9611 | −55.6891 | 4.2691 |
| L-MCNN-BiLSTM | 14.5507 | −116.4053 | 2.2968 | 11.1427 | −89.1420 | 2.3609 | 6.9033 | −55.2267 | 3.1198 |
| AL-MCNN-BiLSTM | 14.5344 | −116.2750 | 0.1842 | 10.9862 | −87.8899 | 0.2230 | 6.5266 | −52.2129 | 0.2894 |

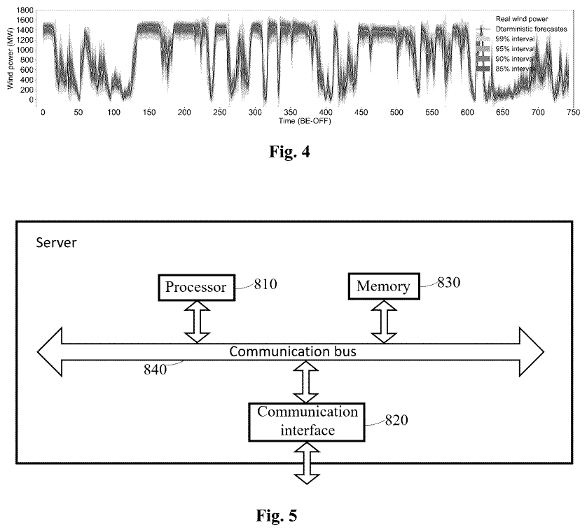

It can be seen from Table 2 that the proposed model AL-MCNN-BiLSTM is better than other benchmark models. Similarly, the superiority of the proposed method can also be seen on Dataset BE-OFF. The PIs and deterministic forecasts of the proposed model on the two datasets are shown in FIG. 3 and FIG. 4. It can be seen that the deterministic forecasting result of AL-MCNN-BiLSTM is closed to the observation, and the obtained probabilistic forecasting results at different confidence levels also accurately describe the uncertainty of wind power forecasts.

From Table 2 and Table 3, it can also be seen that the performance of the deep learning-based probabilistic forecasting method is better than that of the traditional probabilistic forecasting methods GP and QR, and most of the probability distribution-based deep learning models are better than PL-LSTM and PIRR-LSTM. From the forecasting results of PL-LSTM, PIRR-LSTM, AL-CNN, AL-LSTM and AL-BiLSTM, the asymmetric Laplace-based loss function is better than the interval-based loss function PL and PIRR, and the performance of LSTM and BiLSTM is better than that of CNN for probabilistic wind power forecasting. From the comparison of AL-CNN, AL-LSTM and AL-BiLSTM, and the comparison of AL-CNN-LSTM, AL-CNN-BiLSTM, AL-MCNN-LSTM and AL-MCNN-BiLSTM, the hybrid method is better than the single model. Since MCNN makes full use of the multi-scale information in different convolutional layer, it is superior to traditional CNN in spatial feature extraction. In addition, from the comparison of G-MCNN-BiLSTM, L-MCNN-BiLSTM and AL-MCNN-BiLSTM, the performance of the model with the uncertainty characterized by asymmetric Laplace distribution is better than that based on Gaussian and Laplace distribution.

The embodiments also provides an asymmetric Laplace-based wind power forecasting system based on the designed forecasting method. The system includes:
Collection module, obtaining historical wind power data and use the MIC to determine the input variables;
Neural network module, constructing a multi-scale feature fusion module, the input of the model is a 1×1×d×1 tensor, wherein d is the input dimension;
Training module, the loss function is obtained based on the maximum likelihood estimation of the asymmetric Laplace distribution, and the model is trained to predict the parameters of the asymmetric Laplace distribution;
Prediction module, the parameters of the asymmetric Laplace distribution are determined based on the trained model, and the mean statistics of the parameters of the asymmetric Laplace distribution are used as the deterministic forecasts of the wind power.

Based on the same conceive, the embodiment of the present invention also provides a schematic picture of an entity structure. As shown in FIG. 5, the server includes a processor 810, a communication interface 820, a memory 830, and a communication bus 840, Wherein the processor 810, the communication interface 820, and the memory 830 communicate with each other through the communication bus 840. The processor 810 may call the logical instructions in the memory 830 to perform the steps of the asymmetric Laplace distribution-based wind power forecasting method as described in the above embodiments, which include:

Step S1: Obtaining the historical wind power data and use MIC to measure linear and nonlinear relationships between random variables to select optimal inputs, whose values of MIC should be greater than the given threshold;

Step S2: Constructing a neural network-based forecasting model with a multi-scale feature fusion module, the input of the model is a 1×1×d×1 tensor, wherein d is the input dimension;

Step S3: Deriving the loss function based on the maximum likelihood estimation of the asymmetric Laplace distribution, the model is trained with the selected inputs and the desired output to predict the parameters of the asymmetric Laplace distribution;

Step S4: Collecting the estimated parameters of the asymmetric Laplace distribution from the trained model, and using the mean statistics of the estimated asymmetric Laplace distribution as the deterministic forecast of wind power.

In addition, the above-mentioned logical instructions in the memory 830 can be implemented in the form of software functional units and sold or used as independent products, which can be stored in a computer readable storage medium. Based on this understanding, The part of the technical solution of the present invention that contributes to the existing technology can be embodied in the form of a software product. The computer software product is stored in a storage medium and includes a number of instructions to enable a computer device (which may be a personal computer, a server, or a network device, etc.) to perform all or part of the steps of the methods described in the various embodiments of the present invention. The aforementioned storage media include: U disk, mobile hard disk, read-only memory (ROM, Read-Only Memory), random access memory (RAM, Random Access Memory), magnetic disks or optical disks and other media that can store program codes.

Based on the same concept, embodiments of the present invention also provide a non-transitory computer-readable storage medium, the computer-readable storage medium stores computer programs, the computer programs include at least one piece of code. The code can be executed by the main control device to control the main control device to implement the steps of the asymmetric Laplace distribution-based wind power forecasting method as described in the above embodiments, which include:
Step S1: Obtaining the historical wind power data and use MIC to measure linear and nonlinear relationships between random variables to select optimal inputs, whose values of MIC should be greater than the given threshold;
Step S2: Constructing a neural network-based forecasting model with a multi-scale feature fusion module, the input of the model is a 1×1×d×1 tensor, wherein d is the input dimension;
Step S3: Deriving the loss function based on the maximum likelihood estimation of the asymmetric Laplace distribution, the model is trained with the selected inputs and the desired output to predict the parameters of the asymmetric Laplace distribution;
Step S4: Collecting the estimated parameters of the asymmetric Laplace distribution from the trained model, and using the mean statistics of the estimated asymmetric Laplace distribution as the deterministic forecast of wind power.

Based on the same technical conceive, the embodiments of the present application also provide a computer program, which is used to implement the above method embodiments when the computer program is executed by the master control device.

The program may be stored in whole or in part on a storage medium packaged with the processor, and may also be stored in whole or in part in a memory not packaged with the processor.

Based on the same technical conceive, the embodiment of the present application further provides a processor, which is configured to implement the above method embodiment. The aforementioned processor may be a chip.

In summary, the invention provides a wind power forecasting method and system based on an asymmetric Laplace distribution. It utilizes the asymmetric Laplace distribution to model the uncertainty of the power forecasts. First, the maximum information coefficient (MIC) is used to characterize the linear and nonlinear relationship between the target and historical power data to select reasonable and optimal inputs. Then, to avoid the information loss, a multi-scale feature fusion module is proposed which combines the features obtained from different convolutional layers of a convolutional neural network (CNN), thereby further enhancing the feature extraction ability of the traditional CNN. Finally, a BiLSTM is used to extract temporal information and forecast the parameters of asymmetric Laplace distribution.

The foregoing embodiments can be implemented by software, hardware, firmware, or any combination. When implemented by software, it can be implemented in the form of computer program products in whole or in part. The computer program products include one or more computer instructions. When the computer program instructions are loaded and executed on the computer, all or part of the processes or functions described in this application are generated. The computer may be a general-purpose computer, a special-purpose computer, a computer network, or other programmable devices. The computer instructions may be stored in a computer-readable storage medium, or transmitted from one computer-readable storage medium to another computer-readable storage medium. For example, the computer instructions may be transmitted from a website, computer, server, or data center to another website, computer, server or data center via wired (such as coaxial cable, optical fiber, digital subscriber line) or wireless (such as infrared, wireless, microwave, etc.). The computer-readable storage medium may be any available medium that can be accessed by a computer or a data storage device such as a server or a data center integrated with one or more available media. The usable medium may be a magnetic medium (for example, a floppy disk, a hard disk, and a magnetic tape), an optical medium (for example, a DVD), or a semiconductor medium (for example, a solid state disk).

A person of ordinary skill in the art can understand and achieve all or part of the process in the above-mentioned embodiment method, the process can be completed by a computer program instructing relevant hardware, the program can be stored in a computer readable storage medium. The program can execute the processes of the foregoing method embodiments. The aforementioned storage media include: ROM or random storage RAM, magnetic disks or optical discs and other media that can store program codes.

Finally, it should be noted that the above embodiments are only used to illustrate the technical solutions of the present invention, not to limit them. Although the present invention has been described in detail with reference to the foregoing embodiments, those of ordinary skill in the art should understand that: The technical solutions recorded in the foregoing embodiments are modified, or some of the technical features thereof are equivalently replaced. These modifications or replacements do not cause the essence of the corresponding technical solutions to deviate from the spirit and scope of the technical solutions of the embodiments of the present invention.

What is claimed is:

1. A method for the asymmetric Laplace-based wind power forecasting, the method comprising:
Step S1: Obtaining the historical wind power data and use MIC to measure linear and nonlinear relationships between random variables to select optimal inputs, whose values of MIC should be greater than the given threshold;
Step S2: Constructing a neural network-based forecasting model with a multi-scale feature fusion module, the input of the model is a 1×1×d×1 tensor, wherein d is the input dimension;
Step S3: Deriving the loss function based on the maximum likelihood estimation of the asymmetric Laplace distribution, the model is trained with the selected inputs and the desired output to predict the parameters of the asymmetric Laplace distribution;
Step S4: Collecting the estimated parameters of the asymmetric Laplace distribution from the trained model, and using the mean statistics of the estimated asymmetric Laplace distribution as the deterministic forecast of wind power.

2. The method for the asymmetric Laplace-based wind power forecasting according to the claim 1, the Step S1 specifically includes:
Step S11: Obtaining the historical wind power data, and divide it into training set, validation set and test set, which are normalized subsequently;
Step S12: Taking the wind power at time T+i as the target and calculate the MIC between the wind power at time T+i and time T, T−i, T−2i, . . . , T−ni. Then, select the historical wind power whose MIC value is greater than the given threshold as the input variable.

3. The method for the asymmetric Laplace-based wind power forecasting according to the claim 2, the calculation of MIC in the Step S12 includes:
Given N samples D={(xᵢ, yᵢ)|i=1, 2, . . . , N} that related to the input variable X and the output variable Y, all inputs and outputs are divided into m and n intervals, respectively, thus forming an m×n grid G;
According to the empirical joint probability distribution p(x, y) of X and Y, the corresponding empirical marginal distributions p(x) and p(y) can be estimated, under the condition of sample D and grid G, the mutual information MI(X, Y|D, G) between X and Y can be expressed as:
$$MI ( X , y \vert D , G ) = {\sum }_{x ∈ X} {\sum }_{y ∈ Y} p ( x , y ) {log}_{2} ( \frac{p ( x , y )}{p ( x ) p ( y )} ) ;$$
The standardized maximum mutual information NMI*(D,m,n) based on grid G can be expressed as:
$${NMI}^{*} ( D , m , n ) = \frac{{max}_{G} MI ( X , Y \vert D , G )}{log min \{ m , n \}} ;$$
The MIC between X and Y can be computed as:
$$MIC ( X , Y ) = {max}_{m \times n < k ( N )} \{ {NMI}^{*} ( D , m , n ) \} ,$$
wherein k(N) is the function related to the sample size.

4. The method for the asymmetric Laplace-based wind power forecasting according to the claim 1, the multi-scale feature fusion module in the Step S2 includes a 1-dimension CNN (1D-CNN) with three convolutional layers, in which the kernel size is k×1, and the corresponding output is a 1×1×d×k tensor. The output of each convolutional layer is flattened into a 1×1×q tensor, where q=d×k;
The output of the multi-scale feature fusion module is [symbol] _{fusion}= [symbol] _{conv1}+ [symbol] _{conv2}+ [symbol] _{conv3}, where [symbol] _{conv1}, [symbol] _{conv2}, and [symbol] _{conv3} are the flattened outputs of three convolutional layers.

5. The method for the asymmetric Laplace-based wind power forecasting according to the claim 3, the Step S3 specifically includes:
Step S31: Determine the probability distribution function of the asymmetric Laplace distribution:
$$AsyL ( x \vert κ , μ , s ) = \{ \begin{matrix}\frac{κ}{s ( {κ}^{2} + 1 )} exp ( - \frac{κ ( x - μ )}{s} ) , & x \geq μ \\ \frac{κ}{s ( {κ}^{2} + 1 )} exp ( - \frac{{κ}^{- 1} ( x - μ )}{s} ) , & x < μ\end{matrix} ,$$
wherein x∈(−∞,+∞), κ>0, κ is the shape parameter, μ is the position parameter, and s is the scale parameter;
Step S32: For the input xᵢ, the parameters κ, μ, s vary with different features; given N training samples, the likelihood function is:
$$L = {\prod }_{i = 1}^{N} AsyL ( {y}_{i} \vert κ ( {x}_{i} ) , μ ( {x}_{i} ) , s ( {x}_{i} ) ) ;$$
Step S33: Based on the proposed neural network, the parameters of the symmetric Laplace distribution are obtained by maximizing the log-likelihood function. The loss function is:
$$L ( {y}_{i} , {\hat{y}}_{i} ) = - {\sum }_{i}^{N} log κ ( {x}_{i} ) - log ( {κ ( {x}_{i} )}^{2} + 1 ) - log s ( {x}_{i} ) + {\sum }_{i}^{N} \{ \begin{matrix}- \frac{κ ( {x}_{i} ) ( {y}_{i} - μ ( {x}_{i} ) )}{s ( {x}_{i} )} , & {y}_{i} \geq μ ( {x}_{i} ) \\ \frac{{κ ( {x}_{i} )}^{- 1} ( {y}_{i} - μ ( {x}_{i} ) )}{s ( {x}_{i} )} , & {y}_{i} < μ ( {x}_{i} )\end{matrix} ,$$
where ŷᵢ=[μ(xᵢ), κ(xᵢ), s(xᵢ)]. The above loss function is employed to train the proposed neural network.

6. The method for the asymmetric Laplace-based wind power forecasting according to the claim 5, in the Step S4, the deterministic forecasting result of wind power can be seen as the mean statistics of the asymmetric Laplace distribution, which can be expressed as:
$${Mean}_{AsyL} = {μ}^{*} - \frac{{s}^{*} ( {κ}^{* 2} - 1 )}{{κ}^{*}} ,$$
wherein μ*, κ*, s* are the forecasts of the position parameter, shape parameter and scale parameter in the asymmetric Laplace distribution, respectively.

7. A system for the proposed asymmetric Laplace distribution-based wind power forecasting comprising:
Collection module, obtaining historical wind power data and use the MIC to determine the input variables;
Neural network module, constructing a multi-scale feature fusion module, the input of the model is a 1×1×d×1 tensor, wherein d is the input dimension;
Training module, the loss function is obtained based on the maximum likelihood estimation of the asymmetric Laplace distribution, and the model is trained to predict the parameters of the asymmetric Laplace distribution;
Prediction module, the parameters of the asymmetric Laplace distribution are determined based on the trained model, and the mean statistics of the parameters of the asymmetric Laplace distribution are used as the deterministic forecasts of the wind power.
